(19) United States
(12) Patent Application Publication
(10) Pub. No.: US 2025/0016501 A1
(43) Pub. Date: Jan. 9, 2025

(54) EXTERNAL NOISE-BASED MICROPHONE AND SENSOR CONTROL METHOD AND ELECTRONIC DEVICE

(71) Applicant: SAMSUNG ELECTRONICS CO., LTD., Suwon-Si (KR)

(72) Inventors: Seonmi KIM, Suwon-Si (KR); Sangeun Kim, Suwon-Si (KR); Hangil Moon, Suwon-Si (KR); Kyoungho Bang, Suwon-Si (KR); Soonho Baek, Suwon-Si (KR); Jaemo Yang, Suwon-Si (KR); Junwoo Cha, Suwon-Si (KR)

(73) Assignee: SAMSUNG ELECTRONICS CO., LTD., Suwon-Si (KR)

(21) Appl. No.: 18/811,406

(22) Filed: Aug. 21, 2024

Related U.S. Application Data
(63) Continuation of application No. PCT/KR2023/002348, filed on Feb. 17, 2023.

(30) Foreign Application Priority Data
Feb. 21, 2022 (KR) 10-2022-0022248
May 6, 2022 (KR) 10-2022-0056010

(51) Int. Cl. H04R 3/00; G06F 1/08; G06F 1/3212; H04M 9/08

(52) U.S. Cl. CPC H04R 3/005; G06F 1/08; G06F 1/3212; H04M 9/085

(57) ABSTRACT

An electronic device, includes: a sensor; a plurality of microphones; one or more processors; and memory storing instructions that, when executed by the one or more processors, cause the electronic device to: obtain a first sound signal through at least one of the plurality of microphones; obtain a second sound signal through at least one of a plurality of axes of the sensor; identify a noise level from among a plurality of noise levels based on the first sound signal and the second sound signal; control one or more of the plurality of microphones to be turned on or off based on the noise level; and control one or more of the plurality of axes to be turned on or off based on the noise level.

### CROSS-REFERENCE TO RELATED APPLICATIONS

This application is a by-pass continuation application of International Application No. PCT/KR2023/002348, filed on Feb. 17, 2023, which is based on and claims priority to Korean Patent Application No. 10-2022-0022248, filed in the Korean Intellectual Property Office on Feb. 21, 2022, and Korean Patent Application No. 10-2022-0056010, filed in the Korean Intellectual Property Office on May 6, 2022, the disclosures of which are incorporated by reference herein in their entireties.

### BACKGROUND

### 1. Field

Various embodiments of the disclosure relate to an electronic device and a method for controlling a microphone and a sensor.

### 2. Description of Related Art

As wireless communication technology advances, an electronic device may communicate with another electronic device via various wireless communication techniques. Bluetooth communication technology means short-range wireless communication technology that may interconnect electronic devices to exchange data or information. Bluetooth communication technology may have Bluetooth legacy (or classic) network technology or Bluetooth low energy (BLE) network technology and have various kinds of topology, such as piconet or scatternet. Electronic devices may share data at low power using Bluetooth communication technology. Such Bluetooth technology may be used to connect external wireless communication devices and transmit audio data for the content running on the electronic device to an external wireless communication device so that the external wireless communication device may process the audio data and output the result to the user. Bluetooth communication technology-adopted wireless earphones are recently in wide use. For a better performance, wireless earphones with multiple microphones are used.

An electronic device such as a true wireless stereo (TWS)-based wireless earphone may obtain a speech spoken by the user using a microphone. Because the microphone included in the wireless earphone may be physically separated from the user's mouth, external noise (e.g., ambient noise other than speech) as well as the user's speech may be obtained together. Accordingly, the wireless earphone may use beamforming signal processing technology using a plurality of microphones to obtain a high-quality speech from which external noise is removed.

As more microphones are used in wireless earphones, speech signal throughput may be high and power consumption may be high, and even when other modules or components (e.g., sensors) for removing external noise are added in addition to the microphones, power consumed by the added modules or components may increase, causing it inefficient to use power of the battery in the electronic device.

### SUMMARY

Provided is an electronic device, a control method thereof, capable of controlling a microphone and a sensor based on an external noise level.

According to an aspect of the disclosure, an electronic device, includes: a sensor; a plurality of microphones; one or more processors; and memory storing instructions that, when executed by the one or more processors, cause the electronic device to: obtain a first sound signal through at least one of the plurality of microphones; obtain a second sound signal through at least one of a plurality of axes of the sensor; identify a noise level from among a plurality of noise levels based on the first sound signal and the second sound signal; control one or more of the plurality of microphones to be turned on or off based on the noise level; and control one or more of the plurality of axes to be turned on or off based on the noise level.

The electronic device may further include a communication interface, and the one or more processors may be configured to execute the instructions to cause the electronic device to identify the noise level based on the electronic device being in a call state with an external electronic device using the communication interface.

The plurality of microphones may include a first microphone, a second microphone, and a third microphone, and the sensor may include a three-axis acceleration sensor. The plurality of noise levels may include a first noise level and at least one of a second noise level or a third noise level.

The one or more processors may be configured to execute the instructions to cause the electronic device to, based on the noise level being the first noise level, turn on at least one from among the first microphone, the second microphone, and the third microphone, turn off the three-axis acceleration sensor, and control one or more processing clocks of the one or more processors to be a first clock frequency range; based on the noise level being the second noise level, turn on the first microphone, the second microphone, and the third microphone, turn on one or more axes of the three-axis acceleration sensor, turn off one or more other axes of the three-axis acceleration sensor, and control the one or more processing clocks to be a second clock frequency range; and based on the noise level being the third noise level, turn on the first microphone, the second microphone, and the third microphone, turn on a first axis, a second axis, and a third axis of the three-axis acceleration sensor, and control the one or more processing clocks to be a third clock frequency range, wherein the first clock frequency range is less than the second clock frequency range, and the second clock frequency range is less than the third clock frequency range.

The one or more processors may be configured to execute the instructions to cause the electronic device to, based on the noise level being the first noise level and a battery level of the electronic device being less than or equal to a designated battery level, or based on the electronic device being in a continuous call state, the noise level being the first noise level, and the battery level exceeding the designated battery level, turn on one of the first microphone; the second microphone, and the third microphone, and turn off the three-axis acceleration sensor; and based on the electronic device not being in the continuous call state, the noise level being the first noise level, and the battery level of the electronic device exceeding the designated battery level, or based on the noise level being the second noise level, turn on the first microphone, the second microphone, and the third microphone, turn on one or more axes of the three-axis acceleration sensor, and turn off one or more other axes of the three-axis acceleration sensor.

The one or more processors may be configured to execute the instructions to cause the electronic device to, based on the noise level being the first noise level, turn on at least one from among the first microphone, the second microphone, and the third microphone, and turn off the three-axis acceleration sensor; based on the noise level being the second noise level or based on the noise level being the third noise level and a battery level of the electronic device being less than or equal to a designated battery level, turn on the first microphone, the second microphone, and the third microphone, turn on one or more axes of the three-axis acceleration sensor, and turn off one or more other axes of the three-axis acceleration sensor; and based on the noise level being the third noise level and the battery level exceeding the designated battery level, turn on the first microphone, the second microphone, and the third microphone, and turn on a first axis, a second axis, and a third axis of the three-axis acceleration sensor.

The one or more processors may be configured to execute the instructions to cause the electronic device to identify a first speech section and a first non-speech section in the first sound signal; identify a second speech section and a second non-speech section in the second sound signal; and identify the noise level based on a difference between a first signal magnitude of the first non-speech section and a second signal magnitude of the second non-speech section.

According to an aspect of the disclosure, a method of controlling an electronic device based on external noise, includes: obtaining a first sound signal through at least one of a plurality of microphones of the electronic device; obtaining a second sound signal through at least one of a plurality of axes of a sensor of the electronic device; identifying a noise level from among a plurality of noise levels based on the first sound signal and the second sound signal; controlling one or more of the plurality of microphones to be turned on or off based on the noise level; and controlling one or more of the plurality of axes to be turned on or off based on the noise level.

The method may further include identifying the noise level based on the electronic device being in a call state with an external electronic device using a communication interface of the electronic device.

The plurality of microphones may include a first microphone, a second microphone, and a third microphone, and the sensor may include a three-axis acceleration sensor. The plurality of noise levels may include a first noise level and at least one of a second noise level or a third noise level.

The method may further include, based on the noise level being the first noise level, turning on from among the first microphone, the second microphone, and the third microphone, turning off the three-axis acceleration sensor, and controlling one or more processing clocks of one or more processors of the electronic device to be a first clock frequency range; based on the noise level being the second noise level, turning on the first microphone, the second microphone, and the third microphone, turning on one or more axes of the three-axis acceleration sensor, turning off one or more other axes of the three-axis acceleration sensor, and controlling the one or more processing clocks to be a second clock frequency range; based on the noise level being the third noise level, turning on the first microphone, the second microphone, and the third microphone, turning on a first axis, a second axis, and a third axis of the three-axis acceleration sensor, and controlling the one or more processing clocks to be a third clock frequency range, wherein the first clock frequency range is less than or equal to the second clock frequency range, and the second clock frequency range is less than or equal to the third clock frequency range.

The method may further include, based on the noise level is the first noise level and a battery level of the electronic device being less than or equal to a designated battery level, or based on the electronic device being in a continuous call state, the noise level being the first noise level, and the battery level exceeding the designated battery level, turning on one of the first microphone, the second microphone, and the third microphone, and turning off the three-axis acceleration sensor; and based on the electronic device not being in the continuous call state, the noise level being the first noise level, and the battery level exceeding the designated battery level, or based on the noise level being the second noise level, turning on the first microphone, the second microphone, and the third microphone, turning on one or more axes of the three-axis acceleration sensor, and turning off one or more other axes of the three-axis acceleration sensor.

The method may further include, based on the noise level being the first noise level, turning on at least one from among the first microphone, the second microphone, and the third microphone, and turning off the three-axis acceleration sensor; based on the noise level being the second noise level or based on the noise level being the third noise level and a battery level of the electronic device being less than or equal to a designated battery level, turning on the first microphone, the second microphone, and the third microphone, turning on a portion of axes of the three-axis acceleration sensor, and turning off another portion of axes of the three-axis acceleration sensor; and based on the noise level being the third noise level and the battery level exceeding the designated battery level, turning on the first microphone, the second microphone, and the third microphone, and turning on a first axis, a second axis, and a third axis of the three-axis acceleration sensor.

The method may further include identifying a first speech section and a first non-speech section in the first sound signal; identifying a second speech section and a second non-speech section in the second sound signal; and identifying the noise level based on a difference between a first signal magnitude of the first non-speech section and a second signal magnitude of the second non-speech section.

According to an aspect of the disclosure, a non-transitory computer-readable recording medium having instructions recorded thereon, that, when executed by at least one processor, cause the at least one processor to: obtain a first sound signal through at least one of a plurality of microphones of an electronic device; obtain a second sound signal through at least one of a plurality of axes of a sensor of the electronic device; identify a noise level from among a plurality of noise levels based on the first sound signal and the second sound signal; control one or more of the plurality of microphones to be turned on or off based on the noise level; and control one or more of the plurality of axes to be turned on or off based on the noise level.

### BRIEF DESCRIPTION OF THE DRAWINGS

The above and other aspects, features, and advantages of certain embodiments of the present disclosure are more apparent from the following description taken in conjunction with the accompanying drawings, in which:

FIG. 1 is a block diagram illustrating an electronic device in a network environment according to an embodiment;

FIG. 2 is a view illustrating an example of an electronic device and an electronic device capable of receiving and outputting audio data from the electronic device according to an embodiment;

FIG. 3 is a block diagram illustrating a first electronic device according to an embodiment;

FIG. 4A is a view illustrating signals sensed corresponding to three axes, respectively, output from a VPU sensor according to an embodiment;

FIG. 4B is a view illustrating a signal associated with a speech signal obtained from signals sensed corresponding to three axes, respectively, output from a VPU sensor according to an embodiment;

FIG. 5 is a flowchart illustrating an operation of controlling a microphone and a sensor based on external noise in an electronic device according to an embodiment;

FIG. 6 is a flowchart illustrating an operation of controlling a microphone and a sensor based on a first noise level and a second noise level in an electronic device according to an embodiment;

FIG. 7 is a flowchart illustrating an operation of controlling a microphone and sensor based on a first noise level, a second noise level, and a third noise level in an electronic device according to an embodiment;

FIG. 8 is a flowchart illustrating an operation of controlling a microphone and a sensor based on a first noise level, a second noise level, and a battery level in an electronic device according to an embodiment;

FIG. 9 is a flowchart illustrating an operation of controlling a microphone and a sensor based on a first noise level, a second noise level, a third noise level, and a battery level in an electronic device according to an embodiment;

FIG. 10 is a view illustrating an example of identifying a noise level using a sound signal obtained by at least one of microphones and a sound signal obtained by a sensor according to an embodiment; and

FIG. 11 is a view illustrating a notification screen according to a battery state of an electronic device according to an embodiment.

The same or similar reference denotations may be used to refer to the same or similar elements throughout the specification and the drawings.

### DETAILED DESCRIPTION

The terms as used herein are provided merely to describe some embodiments thereof, but not to limit the scope of other embodiments of the present disclosure. It is to be understood that the singular forms “a,” “an,” and “the” include plural references unless the context clearly dictates otherwise. All terms including technical and scientific terms used herein have the same meaning as commonly understood by one of ordinary skill in the art to which the embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

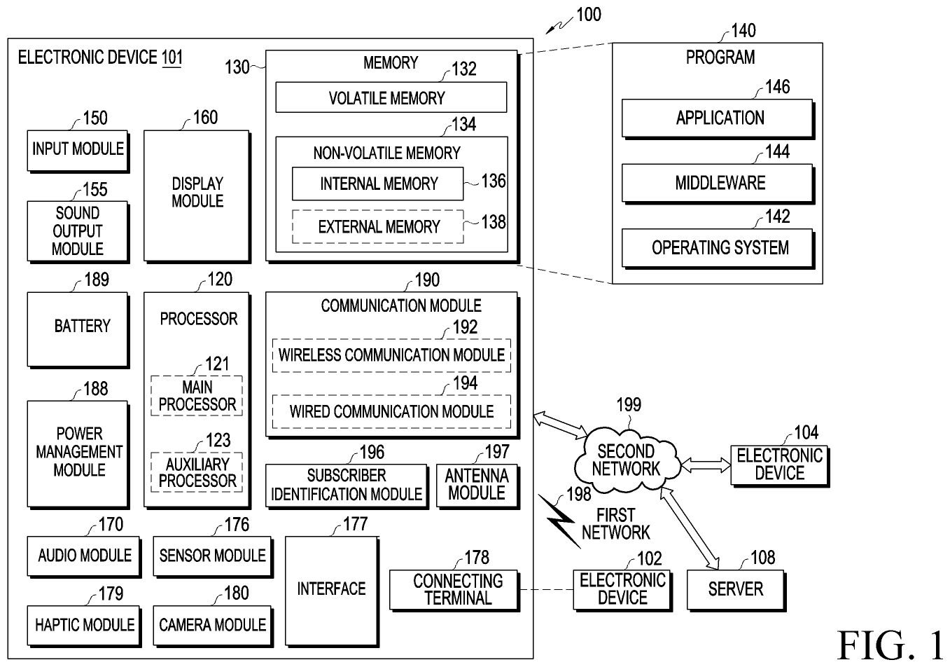

FIG. 1 is a block diagram illustrating an electronic device 101 in a network environment 100 according to various embodiments.

Referring to FIG. 1, the electronic device 101 in the network environment 100 may communicate with at least one of an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190 (or communication interface or communication circuitry), a subscriber identification module (SIM) 196, or an antenna module 197. In an embodiment, at least one (e.g., the connecting terminal 178) of the components may be omitted from the electronic device 101, or one or more other components may be added in the electronic device 101. According to an embodiment, some (e.g., the sensor module 176, the camera module 180, or the antenna module 197) of the components may be integrated into a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be configured to use lower power than the main processor 121 or to be specified for a designated function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. The artificial intelligence model may be generated via machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by other component (e.g., the processor 120) of the electronic device 101, from the outside (e.g., a user) of the electronic device 101. The input module 150 may include, for example, a microphone, a mouse, a keyboard, keys (e.g., buttons), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display 160 may include, for example, a display, a hologram device, or a projector and control circuitry to control a corresponding one of the display, hologram device, and projector. According to an embodiment, the display 160 may include a touch sensor configured to detect a touch, or a pressure sensor configured to measure the intensity of a force generated by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an accelerometer, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or motion) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules or interfaces may communicate with the external electronic device 104 via a first network 198 (e.g., a short-range communication network, such as Bluetooth™, wireless-fidelity (Wi-Fi) direct, or infrared data association (IrDA)) or a second network 199 (e.g., a long-range communication network, such as a legacy cellular network, a 5G network, a next-generation communication network, the Internet, or a computer network (e.g., local area network (LAN) or wide area network (WAN)). These various types of communication modules or interfaces may be implemented as a single component (e.g., a single chip), or may be implemented as multi components (e.g., multi chips) separate from each other. The wireless communication module 192 may identify or authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna.

The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device). According to an embodiment, the antenna module 197 may include one antenna including a radiator formed of a conductor or conductive pattern formed on a substrate (e.g., a printed circuit board (PCB)). According to an embodiment, the antenna module 197 may include a plurality of antennas (e.g., an antenna array). In this case, at least one antenna appropriate for a communication scheme used in a communication network, such as the first network 198 or the second network 199, may be selected from the plurality of antennas by, e.g., the communication module 190. The signal or the power may then be transmitted or received between the communication module 190 and the external electronic device via the selected at least one antenna. According to an embodiment, other parts (e.g., radio frequency integrated circuit (RFIC)) than the radiator may be further formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. The external electronic devices 102 or 104 each may be a device of the same or a different type from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an Internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or health-care) based on 5G communication technology or IoT-related technology.

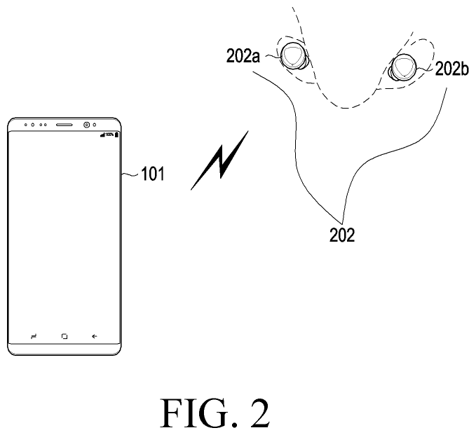

FIG. 2 is a view illustrating an example of an electronic device and an electronic device capable of receiving and outputting audio data from the electronic device according to an embodiment.

Referring to FIG. 2, an electronic device 101 (e.g., the electronic device 101 of FIG. 1) according to an embodiment may transmit audio data to another electronic device 202 through short-range communication. The electronic device 202 (e.g., the electronic device 102 of FIG. 1) may be an electronic device capable of receiving and outputting audio data from the electronic device 101 (hereinafter, also referred to as an “external electronic device”). According to various embodiments, the electronic device 202 may include earphones configured as a pair, a headset, or an audio output device such as a speaker. For example, the electronic device 202 may include a pair of electronic devices including a first electronic device 202a that may be worn on the right ear of the user and a second electronic device 202b that may be worn on the left ear of the user. For example, the first electronic device 202a and the second electronic device 202b may be implemented as a left earphone and a right earphone, respectively, that wirelessly output sound. For example, the electronic device 202 may be implemented as true wireless stereo (TWS)-based wireless earphones.

Each of the first electronic device 202a and the second electronic device 202b according to an embodiment may form a communication link (e.g., a communication link using Bluetooth communication technology) with the external electronic device 101. Each of the first electronic device 202a and the second electronic device 202b may transmit and receive sound-related data to and from the external electronic device 101 through the communication link. Each of the first electronic device 202a and the second electronic device 202b according to an embodiment may convert data received from the external electronic device 101 into sound and may output the converted sound (e.g., audio, music, ambient sound, notification sound, or phone sound) through a speaker. Each of the first electronic device 202a and the second electronic device 202b may obtain an external sound (e.g., the user's speech or ambient sound) through at least one microphone, and may transmit data corresponding to the obtained sound to the external electronic device 101. Each of the first electronic device 202a and the second electronic device 202b according to an embodiment may perform an operation for removing external noise (noise and/or reverberation other than the speech sound) for the sound obtained through at least one microphone in a call state through the external electronic device 101, and may transmit data corresponding to the noise-removed speech sound to the external electronic device 101.

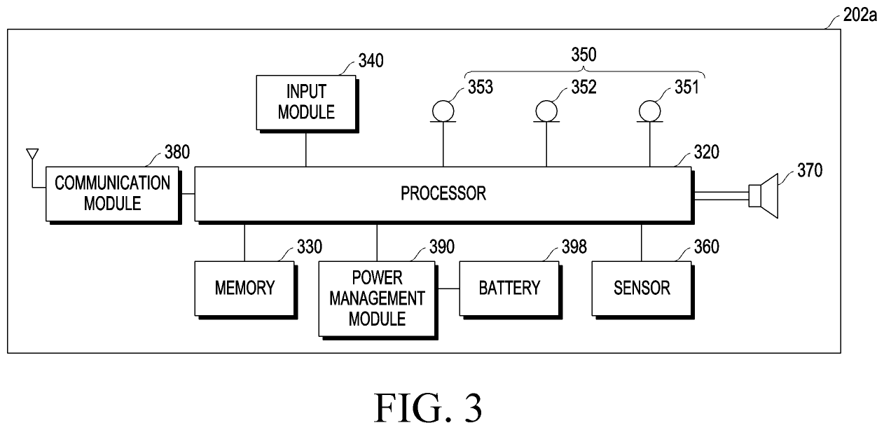

FIG. 3 is a block diagram illustrating a first electronic device according to an embodiment.

Referring to FIG. 3, a first electronic device 202a (e.g., the first electronic device 202a of FIG. 2) according to an embodiment may be implemented as an earphone (e.g., the earphone worn on the left ear) in a first direction. The first electronic device 202a may be paired with a second electronic device 202b (e.g., the second electronic device 202b of FIG. 2), for example, the earphone (e.g., earphone worn on the right ear) in a second direction. For convenience of description, only the configuration of the first electronic device 202a is described herein, but the technical features of the first electronic device 202a may be equally or similarly applied to the second electronic device 202b.

The first electronic device 202a (or the second electronic device 202b) according to an embodiment may include a processor 320, memory 330, an input module 340, microphones 350, a sensor 360, a speaker 370, a communication module 380 (or communication interface or communication circuitry), a power management module 390, and/or a battery 398.

The processor 320 according to an embodiment may be electrically or operatively connected to the memory 330, the input module 340, the microphones 350, the sensor 360, the speaker 370, the communication module 380, and/or the power management module 390, and may perform an overall control operation of the first electronic device 202a.

The input module 340 according to an embodiment may be configured to generate various input signals necessary for operation (or operation control) of the first electronic device 202a. For example, the input module 340 may include a touch pad, a touch panel, or a button. The touch pad may recognize touch inputs in at least one of capacitive, resistive, infrared, or ultrasonic methods. If a capacitive touch pad is provided, physical contact or proximity recognition may be possible. The touch pad may further include a tactile layer. The touch pad including the tactile layer may provide a tactile response to the user. The button may include, e.g., a physical button and/or an optical key. For example, the input module 340 may generate an input signal according to the user input and transmit the input signal to the processor 320. For example, the user input may be an input associated with a call state entry, call state termination, volume control, and/or mute function.

The microphones 350 according to an embodiment may include a first microphone 351, a second microphone 352, and a third microphone 353. The first microphone 351, the second microphone 352, and the third microphone 353 according to an embodiment may obtain a sound signal in an on (e.g., activated or operated) state. At least one (e.g., the first microphone 351 or the inner mic) of the plurality of microphones may be disposed at a position close to the inside of the ear when the first electronic device 202a is inserted into the ear, and other microphones (e.g., the second microphone 352 and the third microphone 353) may be disposed outside the ear while the first electronic device 202a is worn on the user's ear. For example, the first microphone 351 or the inner mic may more easily obtain a sound signal inside the ear than outside the ear than other microphones (e.g., the second microphone 352 and the third microphone 353), and may be more likely to obtain the user's speech sound signal inside the ear than noise outside the ear. Each of the first microphone 351, the second microphone 352, and the third microphone 353 may be turned on (e.g., activated or operated) or off (e.g., deactivated or not operated) under the control of the processor 320. In FIG. 3, the first electronic device 202a is illustrated to include three microphones 350, but the technical spirit of the disclosure may not be limited thereto. For example, the number of microphones may be two or more than three as the plurality of microphones.

The sensor 360 according to an embodiment may measure or detect an amount of change (e.g., vibration, movement, and/or sound) in the surrounding environment. The sensor 360 according to an embodiment may include a speech pick up (VPU) sensor. For example, the VPU sensor 360 may include a plurality of axial acceleration sensors (e.g., a three-axis acceleration sensor, a six-axis acceleration sensor, or other multi-axis acceleration sensors), and may detect a signal (e.g., a vibration signal, a movement signal, or a sound signal) transmitted through at least a portion of the user's body for each axis. For example, when a speech is uttered by the user, the vibration of the vocal cord of the user may be detected by the plurality of axial acceleration sensors to be obtained as a signal of at least a portion of a plurality of sounds related to the speech signal. According to an embodiment, the plurality of axial acceleration sensors may be controlled by the processor 320 to selectively activate or operate (e.g., turn on) at least a portion of the plurality of axes.

The speaker 370 according to an embodiment may output an audio signal (sound signal) under the control of the processor 320.

The communication module 380 according to an embodiment may support short-range wireless communication with the external electronic device 101 and/or the second electronic device 202b. The communication module 380 according to an embodiment may transmit and receive audio data (e.g., speech data) from the external electronic device 101 in a call state through communication with the external electronic device 101. According to an embodiment, the short-range communication may include, e.g., at least one of wireless fidelity (Wi-Fi), Bluetooth, IrDA, or near field communication (NFC).

The power management module 390 according to an embodiment may manage power use of the battery 398 in the first electronic device 202a. According to an embodiment, the power management module 390 may adjust power supplied to the processor 320 based on a signal provided according to a load to be processed by the processor 320, or may adjust power provided to each component (e.g., the memory, the communication module, the input module, and/or the sensor) in addition to the processor 320. The power management module 390 according to an embodiment may include a battery charging module. According to an embodiment, the power management module 390 may receive power from the external power supply device wiredly or wirelessly to charge the battery 398.

The processor 320 according to an embodiment may identify the noise level based on the sound signal (e.g., the “first sound signal”) obtained through the microphones 350 (or at least a portion of the microphones 350) and the sound signal (e.g., the “second sound signal”) obtained through the sensor 360, based on entry into the call state through the communication connection with the electronic device 101. For example, the first sound signal is a sound signal received through each of the first microphone 351 to the third microphone 353, and may be a signal including a speech sound signal of the user on the call and ambient noise. For example, the second sound signal may be a signal sensed by the vibration of the vocal cords of the user when the speech is uttered by the user. The processor 320 according to an embodiment may identify (calculate, determine, judge, or identify) the signal to noise ratio (SNR) value using the first sound signal and the second sound signal, and may identify (determine, judge, or identify) the noise level based on the identified SNR value. For example, two or more noise levels may be identified based on at least one threshold. For example, the noise level may be identified as a first noise level (e.g., a quiet environment) and a second noise level (e.g., a normal environment), may be identified as a first noise level (e.g., a quiet environment), a second noise level (e.g., a normal environment), or a third noise level (e.g., a noisy environment), may be identified as a first noise level (e.g., a quiet environment), a second noise level (e.g., a normal environment), a third noise level (e.g., a noisy environment), or a fourth noise level (e.g., a high noisy environment), or may be identified as more noise levels. For example, the processor 320 may identify the noise level as the first noise level (e.g., the quiet environment) when the SNR value exceeds a designated first threshold, identify the noise level as the second noise level (e.g., the normal environment) when the SNR value is less than or equal to the first threshold and exceeds a second threshold less than the first threshold, identify the noise level as the third noise level (e.g., the noisy environment) when the SNR value is less than or equal to the second threshold and exceeds a third threshold less than the second threshold, and identify the noise level as the fourth noise level (e.g., the high-noisy environment) when the SNR value is less than or equal to the third threshold. For example, the processor 320 may identify a non-speech section (e.g., noise only section) other than a section (e.g., speech section) including a speech in the first sound signal obtained through the microphones 350 (or at least a portion of microphones of the microphones 350), identify a non-speech section (e.g., noise only section) other than a section (e.g., speech section) including a speech in the second sound signal obtained through the sensor 360, compare the signal magnitude of the non-speech section of the first sound signal with the signal magnitude of the non-speech section of the second sound signal to determine the level of the external noise signal and identify the level where the level of the external noise signal belongs among the plurality of noise levels. For example, when the level of the external noise signal is less than or equal to a designated first external noise signal level threshold, the processor 320 may identify the noise level as the first noise level (e.g., the quiet environment). When the level of the external noise signal exceeds the first noise signal level threshold and is less than or equal to a designated second noise signal level threshold larger than the first noise signal level threshold, the processor 320 may identify the noise level as the second noise level (e.g., the normal environment). When the level of the external noise signal exceeds the second noise signal level threshold and is less than or equal to a designated third noise signal level threshold larger than the second noise signal level threshold, the processor 320 may identify the noise level as the third noise level (e.g., the noisy environment). When the level of the external noise signal exceeds the third noise signal level threshold, the processor 320 may identify the noise level as the fourth noise level (e.g., the high-noisy environment). The processor 320 according to an embodiment may control at least one microphone among the microphones 350 (e.g., the first microphone 351 to the third microphone 353) in the call state, may control at least one axis in the call state among the plurality of axes of the sensor 360, and may control the number of processing clocks of the processor 320, based on the identified noise level. For example, the processor 320 may turn on a portion of microphones (e.g., one or two of the first microphone 351, the second microphone 352, and the third microphone 353) of the first microphone 351 to the third microphone 353 based on the first noise level in the call state, may control the sensor 360 not to be turned on, and may control the number of processing clocks of the processor 320 to be a first clock count (or a first clock range). For example, the processor 320 may control the first microphone 351 to the third microphone 353 to be turned on based on the second noise level in the call state, may control only a portion of the plurality of axes to be turned on using the sensor 360, and may control the number of processing clocks of the processor 320 to be a second clock count (or a second clock range) higher than the first clock count (or the first clock range). For example, the processor 320 may control the first microphone 351 to the third microphone 353 to be turned on based on the third noise level in the call state, may control all of the plurality of axes to be turned on using the sensor 360, and may control the number of processing clocks of the processor 320 to be a third clock count (or a third clock range) higher than the second clock count (or the second clock range).

The processor 320 according to an embodiment may perform a call function while the number of processing clocks of the processor 320, the sensor 360, and the microphones 350 are controlled based on the identified noise level. For example, when the first noise level is identified, the processor 320 may transmit audio data obtained by processing the first sound signal received through a portion of microphones (e.g., one or two of the first microphone 351, the second microphone 352, and the third microphone 353) of the first microphone 351 to the third microphone 353 to the external electronic device 101 through the communication module 380 based on the first clock count. For example, when the second noise level is identified, the processor 320 may transmit the audio data obtained by processing the first sound signal received in a beamforming manner through the first microphone 351 to the third microphone 353 and the second sound signal obtained through at least a portion of the axes of the sensor 360 (e.g., one or two of the first axis, the second axis, and the third axis) to the external electronic device 101 through the communication module 380 based on the second clock count. For example, when the third noise level is identified, the processor 320 may transmit the audio data obtained by processing the first sound signal received in a beamforming manner through the first microphone 351 to the third microphone 353 and the second sound signal obtained through all the axes (e.g., three axes or six axes) of the sensor 360 to the external electronic device 101 through the communication module 380 based on the third clock count.

The memory 330 according to an embodiment may store various data and/or information used by at least one component (e.g., the processor 320, the input module 340, the microphones 350, the sensor 360, the speaker 370, the communication module 380, and/or the power management module 390) of the first electronic device 202a. The various data may include, for example, software (e.g., the program) and input data or output data for a command related thereto. For example, the memory 330 may store instructions for performing an operation of the first electronic device 202a (or the processor 320).

The first electronic device 202a according to an embodiment may further include a display device (e.g., a display). The display device may be configured to provide various screen interfaces necessary for operating the first electronic device 202a. The display device may provide a user interface for controlling the call state or controlling the axes of microphones or sensors associated with the noise level. According to an embodiment, the display device may provide a user interface related to a function of receiving audio data from the external electronic device 101 or a function of transmitting audio data to the external electronic device 101. For example, the display device may include a light emitting means such as a light emitting diode (LED). For example, the light emitting means may be controlled to emit a color of light corresponding to charging or completion of charging. For example, when the first electronic device 202a is communicatively connected to the external electronic device 101, the light emitting means may be controlled to emit light of a color.

According to various embodiments, the first electronic device 202a may further include various modules depending on the form of provision thereof. There are many variations according to the convergence trend of digital devices, so it is not possible to list them all, but components equivalent to the above-mentioned components may be further included in the first electronic device 202a. Further, in the first electronic device 202a according to an embodiment, components may be replaced with other components according to the form in which it is provided. This will be easily understood by those of ordinary skill in the art. Further, although the configuration of the first electronic device 202a has been described in the above description, the technical features of the first electronic device 202a may be equally or similarly applied to the second electronic device 202b, and the description of the second electronic device 202b may be implemented by one of ordinary skill in the art through the description of the first electronic device 202a.

According to various embodiments, an electronic device (e.g., the electronic device 102 of FIG. 1, the electronic device 202a of FIG. 2, or the electronic device 202b of FIG. 2) may comprise a sensor (e.g., the sensor 360 of FIG. 3), microphones (e.g., 350 of FIG. 3), and a processor (e.g., the processor 320 of FIG. 3). The processor may be configured to obtain a first sound signal through at least a portion of the microphones, obtain a second sound signal through at least one of axes of the sensor, identify a noise level among a plurality of noise levels based on the first sound signal and the second sound signal, control each of the microphones to be turned on or off based on the identified noise level, and control each of the plurality of axes of the sensor to be turned on or off based on the identified noise level.

According to various embodiments, the electronic device may further comprise a communication module (e.g., the communication module 380 of FIG. 3). The processor may be configured to identify the noise level in a call state with an external electronic device using the communication module.

According to various embodiments, the microphones may include a first microphone, a second microphone, and a third microphone, and the sensor may include a three-axis acceleration sensor.

According to various embodiments, the plurality of noise levels may include a first noise level and a second noise level, or includes the first noise level, the second noise level, and a third noise level.

According to various embodiments, the processor may be configured to, when the identified noise level is the first noise level, turn on a portion of the first microphone, the second microphone, and the third microphone and turn off the three-axis acceleration sensor, when the identified noise level is the second noise level, turn on the first microphone, the second microphone, and the third microphone, turn on a portion of axes of the three-axis acceleration sensor and turn off another portion of axes of the three-axis acceleration sensor, and when the identified noise level is the third noise level, turn on the first microphone, the second microphone, and the third microphone, and turn on a first axis, a second axis, and a third axis of the three-axis acceleration sensor.

According to various embodiments, the processor may be configured to, when the identified noise level is the first noise level, control a processing clock of the processor to be a first clock frequency range, when the identified noise level is the second noise level, control the processing clock of the processor to be a second clock frequency range, and when the identified noise level is the third noise level, control the processing clock of the processor to be a third clock frequency range. The first clock frequency range may be less than the second clock frequency range, and the second clock frequency range may be less than the third clock frequency range.

According to various embodiments, the processor may be configured to, when the identified noise level is the first noise level and a battery level of the electronic device is less than or equal to a designated battery level, or in a continuous call state in a state in which the identified noise level is the first noise level and the battery level of the electronic device exceeds the designated battery level, turn on one of the first microphone, the second microphone, and the third microphone, and turn off the three-axis acceleration sensor, and not in the continuous call state in a state in which the identified noise level is the first noise level and the battery level of the electronic device exceeds the designated battery level, or when the identified noise level is the second noise level, turn on the first microphone, the second microphone, and the third microphone, turn on a portion of axes of the three-axis acceleration sensor, and turn off another portion of axes of the three-axis acceleration sensor.

According to various embodiments, the processor may be configured to, when the identified noise level is the first noise level, turn on a portion of the first microphone, the second microphone, and the third microphone, and turn off the three-axis acceleration sensor, when the identified noise level is the second noise level or the identified noise level is a third noise level and the battery level of the electronic device is less than or equal to the designated battery level, turn on the first microphone, the second microphone, and the third microphone, turn on a portion of axes of the three-axis acceleration sensor, and turn off another portion of axes of the three-axis acceleration sensor, and when the identified noise level is the third noise level and the battery level of the electronic device exceeds the designated battery level, turn on the first microphone, the second microphone, and the third microphone, and turn on a first axis, a second axis, and a third axis of the three-axis acceleration sensor.

According to various embodiments, the processor may be configured to identify a first speech section and a first non-speech section in the first sound signal obtained through at least a portion of the microphones, identify a second speech section and a second non-speech section in the second sound signal obtained through at least one of the axes of the sensor, and identify the noise level based on a difference between a signal magnitude of the first non-speech section and a signal magnitude of the second non-speech section.

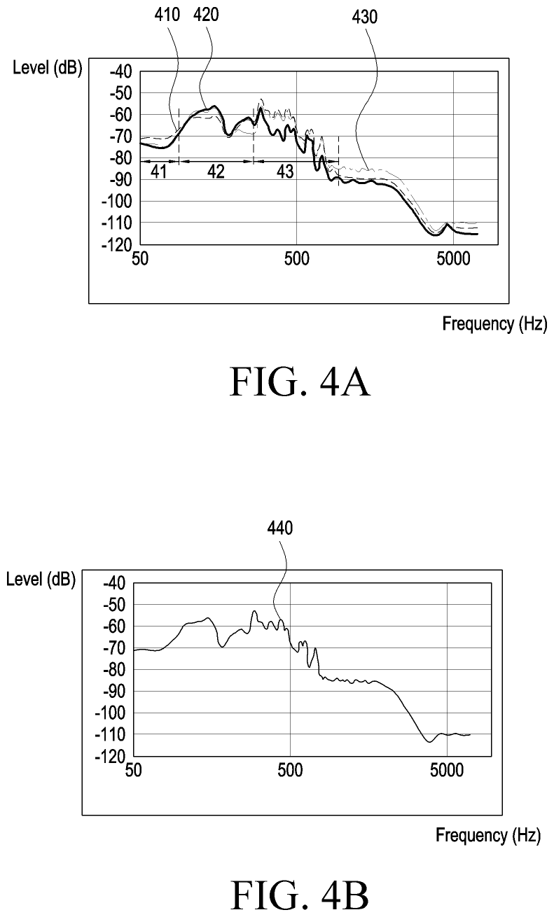

FIG. 4A is a view illustrating sensed signals corresponding to three axes, respectively, output from a VPU sensor according to an embodiment, and FIG. 4B is a view illustrating a signal associated with a speech signal obtained from signals sensed corresponding to three axes, respectively, output from a VPU sensor according to an embodiment.

Referring to FIG. 4A, the horizontal axis may denote the frequency (Hz), and the vertical axis may denote the signal level (or magnitude) (dB). When all of the three axes (e.g., the x-axis, the y-axis, and the z-axis) are used, the VPU sensor 360 (e.g., the sensor 360 of FIG. 3) according to an embodiment may output each of a signal 410 (e.g., a dotted line) (hereinafter, an x-axis signal) sensed based on the x-axis, a signal 420 (e.g., a solid line) (hereinafter, a y-axis signal) sensed based on the y-axis, and a signal 430 (e.g., a dash-dotted line) (hereinafter, a z-axis signal) sensed based on the z-axis. According to an embodiment, the signal sensed based on each axis of the VPU sensor 360 may be a signal obtained by detecting vibration (movement) by the vocal cords of the user when the speech is uttered by the user. According to an embodiment, the respective signals of the axes of the VPU sensor 360 may not have the same value, and a dominant signal (e.g., a signal having a high level) among the respective signals of axes may be identified for each frequency interval (e.g., a low band, a medium band, or a high band). For example, the processor 320 may identify the x-axis signal having the highest level among the respective signals of axes in a first band 42, may identify the y-axis signal having the highest level among the respective signals of axes in a second band 42, and may identify the x-axis signal having the highest level among the respective signals of axes in a third band 43. The range of the band may be designated or changed to any other range based on a change in respective signals of axes, and one of all of the signals may be selected without designating a range.

Referring to FIG. 4B, the processor 320 (e.g., the processor 320 of FIG. 3) according to an embodiment may identify an axis signal having the highest level among respective signals of axes in each of the bands, obtain a signal 440 (e.g., a second sound signal) related to a speech signal based on the axis signal having the highest level among the respective signals of axes in each of the bands, and use the signal 440 for audio signal processing.

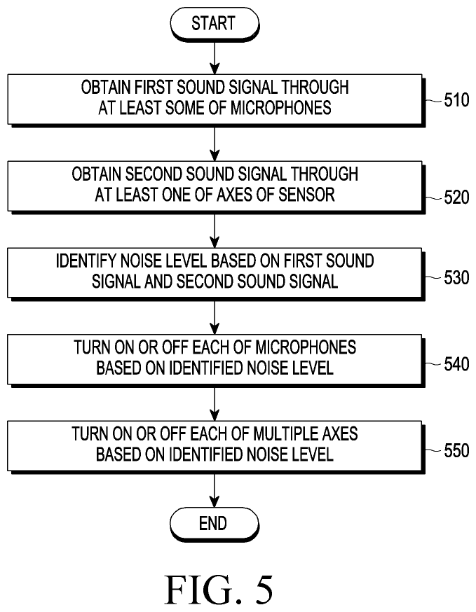

FIG. 5 is a flowchart illustrating an operation of controlling a microphone and a sensor based on external noise in an electronic device according to an embodiment.

Referring to FIG. 5, a processor (e.g., the processor 320 of FIG. 3) of an electronic device (e.g., the electronic device 102 of FIG. 1, the first electronic device 202a of FIG. 2 or 3, or the second electronic device 202b of FIG. 2) according to an embodiment may perform at least one of operations 510 to 550.

In operation 510, the processor 320 according to an embodiment may obtain a sound signal (e.g., a first sound signal) obtained through the microphones 350 (e.g., the microphones 350 of FIG. 3) (or at least a portion of the microphones 350), based on entering a call state through a communication connection with the external electronic device 101 (e.g., the electronic device 101 of FIG. 1 or the electronic device 101 of FIG. 2).

In operation 520, the processor 320 according to an embodiment may perform a sound signal (e.g., a second sound signal) obtained through at least one of axes (e.g., three axes) of the sensor 360 (e.g., the sensor 360 of FIG. 3).

In operation 530, the processor 320 according to an embodiment may identify the noise level based on the obtained sound signals (e.g., the first sound signal and the second sound signal). For example, the first sound signal is a sound signal received through each of the first microphone 351 to the third microphone 353, and may be a signal including a speech sound signal of the user on the call and ambient noise. For example, the second sound signal may be a signal sensed by the vibration of the vocal cords of the user when the speech is uttered by the user. The processor 320 according to an embodiment may identify (calculate, determine, judge, or identify) the signal to noise ratio (SNR) value using the first sound signal and the second sound signal, and may identify (determine, judge, or identify) the noise level based on the identified SNR value. For example, two or more noise levels may be identified based on at least one threshold. For example, the noise level may be identified as a first noise level (e.g., a quiet environment) and a second noise level (e.g., a normal environment), may be identified as a first noise level (e.g., a quiet environment), a second noise level (e.g., a normal environment), or a third noise level (e.g., a noisy environment), may be identified as a first noise level (e.g., a quiet environment), a second noise level (e.g., a normal environment), a third noise level (e.g., a noisy environment), or a fourth noise level (e.g., a high noisy environment), or may be identified as more noise levels. For example, the processor 320 may identify the noise level as the first noise level (e.g., the quiet environment) when the SNR value exceeds a designated first threshold, identify the noise level as the second noise level (e.g., the normal environment) when the SNR value is less than or equal to the first threshold and exceeds a second threshold less than the first threshold, identify the noise level as the third noise level (e.g., the noisy environment) when the SNR value is less than or equal to the second threshold and is larger than a third threshold, and identify the noise level as the fourth noise level (e.g., the high-noisy environment) when the SNR value is less than (or less than or equal to) the third threshold smaller than the second threshold. For example, the processor 320 may identify a non-speech section (e.g., noise only section) other than a section (e.g., speech section) including a speech in the first sound signal obtained through the microphones 350 (or at least a portion of microphones of the microphones 350), identify a non-speech section (e.g., noise only section) other than a section (e.g., speech section) including a speech in the second sound signal obtained through the sensor 360, compare the signal magnitude of the non-speech section of the first sound signal with the signal magnitude of the non-speech section of the second sound signal to determine the level of the external noise signal and identify the level where the level of the external noise signal belongs among the plurality of noise levels.

In operation 540, the processor 320 according to an embodiment may control at least one microphone among the microphones 350 (e.g., the first microphone 351 to the third microphone 353) in the call state, based on the identified noise level. In operation 550, the processor 320 according to an embodiment may control at least one of the plurality of axes of the sensor 360 in the call state and may control the number of processing clocks. For example, the processor 320 may control to turn on (e.g., activate or operate) a portion of microphones (e.g., one or two of the first microphone 351, the second microphone 352, and the third microphone 353) of the first microphone 351 to the third microphone 353 based on the first noise level in the call state, may control the sensor 360 not to be turned on (e.g., to be turned off or deactivated or not to be operated), and may control the number of processing clocks of the processor 320 to be a first clock count (or a first clock range). For example, the processor 320 may control the first microphone 351 to the third microphone 353 to be turned on based on the second noise level in the call state, may control only a portion (e.g., one or two of the first axis, the second axis, and the third axis) of the plurality of axes to be turned on using the sensor 360, and may control the number of processing clocks of the processor 320 to be a second clock count (or a second clock range) higher than the first clock count (or the first clock range). For example, the processor 320 may control the first microphone 351 to the third microphone 353 to be turned on based on the third noise level in the call state, may control all of the plurality of axes to be turned on using the sensor 360, and may control the number of processing clocks of the processor 320 to be a third clock count (or a third clock range) higher than the second clock count (or the second clock range).

The processor 320 according to an embodiment may perform the call function based on performing the operations 510 to 550 of FIG. 5. For example, the processor 320 may perform the call function in a state in which the on or off of each of the microphones 350, the on or off of each of the plurality of axes of the sensor 360, and/or the number of processing clocks of the processor 320 is controlled based on the identified noise level. For example, at the first noise level, the processor 320 may transmit audio data obtained by processing the first sound signal received through a portion of microphones (e.g., one or two of the first microphone 351, the second microphone 352, and the third microphone 353) of the first microphone 351 to the third microphone 353 to the external electronic device 101 through the communication module 380 (e.g., the communication module 380 of FIG. 3) based on the first clock count. For example, at the second noise level, the processor 320 may transmit the audio data obtained by processing the first sound signal received in a beamforming manner through the first microphone 351 to the third microphone 353 and the second sound signal obtained through at least one axis (e.g., the first axis) among the axes of the sensor 360 to the external electronic device 101 through the communication module 380 based on the second clock count. For example, at the third noise level, the processor 320 may transmit the audio data obtained by processing the first sound signal received in a beamforming manner through the first microphone 351 to the third microphone 353 and the second sound signal obtained through all the axes (e.g., three axes or six axes) of the sensor 360 to the external electronic device 101 through the communication module 380 based on the third clock count.

A method of controlling a microphone and a sensor based on external noise in an electronic device (e.g., the electronic device 102 of FIG. 1, the electronic device 202a of FIG. 2, or the electronic device 202b of FIG. 2) according to various embodiments may comprise obtaining a first sound signal through at least a portion of microphones of the electronic device, obtaining a second sound signal through a sensor of the electronic device, identifying a noise level among a plurality of noise levels based on the first sound signal and the second sound signal, controlling to turn on or off each of the microphones based on the identified noise level, and controlling to turn on or off each of a plurality of axes of the sensor based on the identified noise level.

According to various embodiments, the electronic device may identify the noise level in a call state with an external electronic device using a communication module of the electronic device.

According to various embodiments, the microphones may include a first microphone, a second microphone, and a third microphone, and the sensor may include a three-axis acceleration sensor.

According to various embodiments, the plurality of noise levels may include a first noise level and a second noise level, or includes the first noise level, the second noise level, and a third noise level.

According to various embodiments, the method may further comprise, when the identified noise level is the first noise level, turning on a portion of the first microphone, the second microphone, and the third microphone and turn off the three-axis acceleration sensor, when the identified noise level is the second noise level, turning on the first microphone, the second microphone, and the third microphone, turning on a first axis of the three-axis acceleration sensor and turning off a second axis and a third axis of the three-axis acceleration sensor, and when the identified noise level is the third noise level, turning on the first microphone, the second microphone, and the third microphone, and turning on the first axis, the second axis, and the third axis of the three-axis acceleration sensor.

According to various embodiments, the method may further comprise, when the identified noise level is the first noise level, controlling a processing clock of the processor to be a first clock frequency range, when the identified noise level is the second noise level, controlling the processing clock of the processor to be a second clock frequency range, and when the identified noise level is the third noise level, controlling the processing clock of the processor to be a third clock frequency range. The first clock frequency range may be less than the second clock frequency range, and the second clock frequency range may be less than the third clock frequency range.

According to various embodiments, the method may further comprise, when the identified noise level is the first noise level and a battery level of the electronic device is less than or equal to a designated battery level, or in a continuous call state in a state in which the identified noise level is the first noise level and the battery level of the electronic device exceeds the designated battery level, turning on one of the first microphone, the second microphone, and the third microphone, and turning off the three-axis acceleration sensor, and not in the continuous call state in a state in which the identified noise level is the first noise level and the battery level of the electronic device exceeds the designated battery level, or when the identified noise level is the second noise level, turning on the first microphone, the second microphone, and the third microphone, turning on a portion of axes of the three-axis acceleration sensor, and turning off another portion of axes of the three-axis acceleration sensor.

According to various embodiments, the method may further comprise, when the identified noise level is the first noise level, turning on a portion of the first microphone, the second microphone, and the third microphone, and turning off the three-axis acceleration sensor, when the identified noise level is the second noise level or the identified noise level is a third noise level and the battery level of the electronic device is less than or equal to the designated battery level, turning on the first microphone, the second microphone, and the third microphone, turning on a portion of axes of the three-axis acceleration sensor, and turning off another portion of axes of the three-axis acceleration sensor, and when the identified noise level is the third noise level and the battery level of the electronic device exceeds the designated battery level, turning on the first microphone, the second microphone, and the third microphone, and turning on a first axis, a second axis, and a third axis of the three-axis acceleration sensor.

According to various embodiments, the method may further comprise identifying a first speech section and a first non-speech section in the first sound signal obtained through at least a portion of the microphones, identifying a second speech section and a second non-speech section in the second sound signal obtained through at least one of the axes of the sensor, and identifying the noise level based on a difference between a signal magnitude of the first non-speech section and a signal magnitude of the second non-speech section.

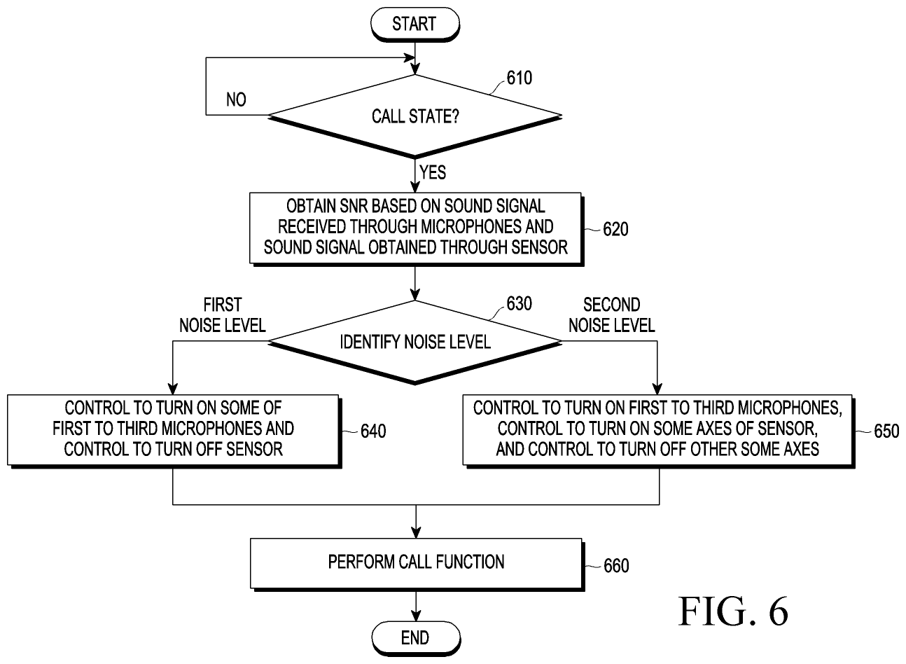

FIG. 6 is a flowchart illustrating an operation of controlling a microphone and a sensor based on a first noise level and a second noise level in an electronic device according to an embodiment.

Referring to FIG. 6, a processor (e.g., the processor 320 of FIG. 3) of an electronic device (e.g., the electronic device 102 of FIG. 1, the first electronic device 202a of FIG. 2 or 3, or the second electronic device 202b of FIG. 2) according to an embodiment may perform at least one of operations 610 to 660.

In operation 610, the processor 320 according to an embodiment may identify whether a call state is entered through a communication connection with the external electronic device 101 (e.g., the electronic device 101 of FIG. 1 or the electronic device 101 of FIG. 2). For example, the processor 320 may identify whether audio data transmission/reception corresponding to the call state with the external electronic device 101 starts. When the electronic device (e.g., the electronic device 102 of FIG. 1, the first electronic device 202a of FIG. 2 or 3, or the second electronic device 202b of FIG. 2) is not in the call state, the processor 320 according to an embodiment may perform a function in another state (e.g., an audio data playback function in a music playback state), or may wait or end in an idle state.

In operation 620, the processor 320 according to an embodiment may identify the signal-to-noise ratio (SNR) based on the sound signal (e.g., the first sound signal) obtained through the microphones 350 (e.g., the microphones 350 of FIG. 3) (or at least a portion of the microphones 350) and the sound signal (e.g., the second sound signal) obtained through the sensor 360 (e.g., the sensor 360 of FIG. 3) in the call state through communication connection with the external electronic device 101. For example, the processor 320 may identify a non-speech section (e.g., noise only section) other than a section (e.g., speech section) including a speech in the first sound signal obtained through the microphones 350 (or at least a portion of microphones of the microphones 350), identify a non-speech section (e.g., noise only section) other than a section (e.g., speech section) including a speech in the second sound signal obtained through the sensor 360, compare the signal magnitude of the non-speech section of the first sound signal with the signal magnitude of the non-speech section of the second sound signal and identify the level of the external noise signal based on a difference between the signal magnitude of the non-speech section of the first sound signal and the signal magnitude of the non-speech section of the second sound signal.

In operation 630, the processor 320 according to an embodiment may identify a noise level. For example, the processor 320 may identify (determine, judge, or identify) the noise level or identify the level where the external noise signal belongs among the plurality of noise levels based on the identified SNR value (or the level of the external noise signal). The processor 320 according to an embodiment may identify which noise level the current noise level belongs to, of the first noise level (e.g., the quiet environment) and the second noise level (e.g., the normal environment), based on the identified SNR value (or the level of the external noise signal).

In operation 640, the processor 320 according to an embodiment may turn on (e.g., activate or operate) a portion of microphones (e.g., one or two of the first microphone 351, the second microphone 352, or the third microphone 353) of the first microphone 351 to the third microphone 353 and may turn off (e.g., deactivate or not operate) the sensor 360 at the first noise level. The processor 320 according to an embodiment may further control the processing clock of the processor 320 to be the first clock count (or the first clock range) at the first noise level.

In operation 650, the processor 320 according to an embodiment may control to turn on the first microphone 351 to the third microphone 353 based on the noise level being the second noise level, may control to turn on a portion of axis (e.g., one or two axes) of the three axes of the sensor 360, and may control to turn off the other axis (e.g., the remaining axis that is not turned on). For example, the processor 320 may control to turn on the first axis of the three axes of the sensor 360 and control to turn off the second axis and the third axis based on the noise level being the second noise level. For example, based on the noise level being the second noise level, the processor 320 may control the first axis and the second axis of the three axes of the sensor 360 to be turned on, and may control the third axis to be turned off. According to an embodiment, even when the number of axes of the sensor 360 exceeds three, only a portion of designated axes may be controlled to be turned on. The processor 320 according to an embodiment may further control the processing clock of the processor 320 to be the second clock count (or the second clock range) at the second noise level. For example, the first clock may have a clock frequency lower than that of the second clock.

In operation 660, the processor 320 according to an embodiment may perform a call function. For example, at the first noise level, the processor 320 may transmit audio data obtained by processing the sound signal received through a portion of microphones (e.g., one or two of the first microphone 351, the second microphone 352, and the third microphone 353) of the first microphone 351 to the third microphone 353 to the external electronic device 101 through the communication module 380 based on the first clock count. For example, at the second noise level, the processor 320 may transmit the audio data obtained by processing the sound signal received in a beamforming manner through the first microphone 351 to the third microphone 353 and the sound signal obtained through a portion of axes of the sensor 360 (e.g., one or two of the first axis, the second axis, and the third axis) to the electronic device 101 through the communication module 380 based on the second clock count.

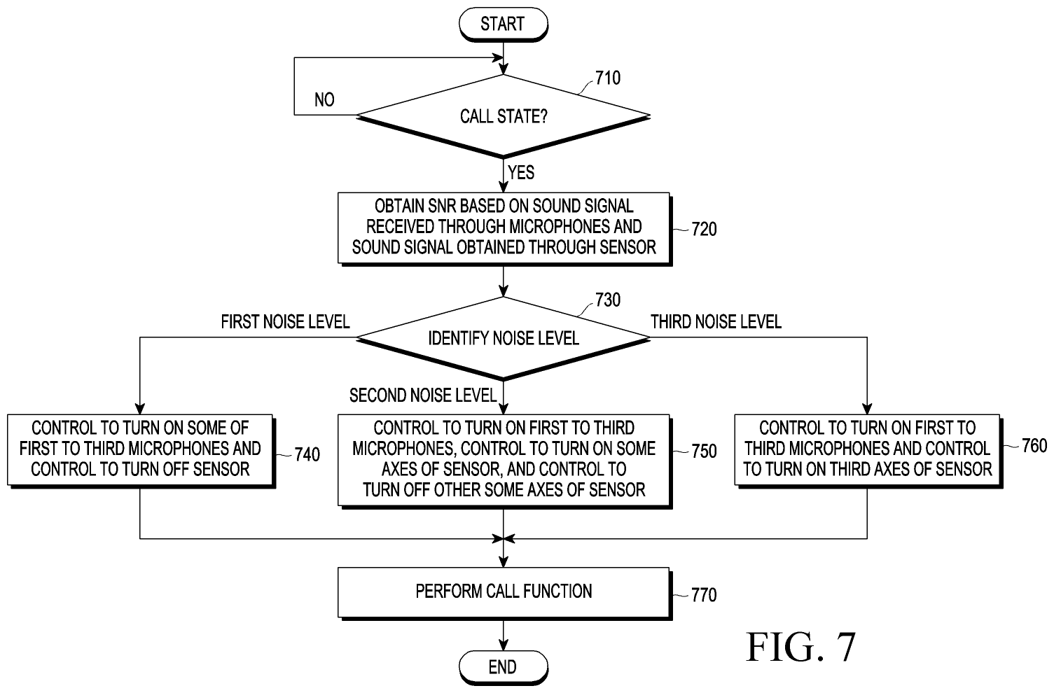

FIG. 7 is a flowchart illustrating an operation of controlling a microphone and sensor based on a first noise level, a second noise level, and a third noise level in an electronic device according to an embodiment.

Referring to FIG. 7, a processor (e.g., the processor 320 of FIG. 3) of an electronic device (e.g., the electronic device 102 of FIG. 1, the first electronic device 202a of FIG. 2 or 3, or the second electronic device 202b of FIG. 2) according to an embodiment may perform at least one of operations 710 to 770.

In operation 710, the processor 320 according to an embodiment may identify whether a call state is entered through a communication connection with the external electronic device 101 (e.g., the electronic device 101 of FIG. 1 or the electronic device 101 of FIG. 2). For example, the processor 320 may identify whether audio data transmission/reception corresponding to the call state with the external electronic device 101 starts. When the processor 320 is not in the call state, the processor 320 according to an embodiment may perform a function in another state (e.g., an audio data playback function in a music playback state), or may wait or end in an idle state.

In operation 720, the processor 320 according to an embodiment may identify the signal-to-noise ratio (SNR) based on the sound signal (e.g., the first sound signal) obtained through the microphones 350 (e.g., the microphones 350 of FIG. 3) (or at least a portion of the microphones 350) and the sound signal (e.g., the second sound signal) obtained through the sensor 360 (e.g., the sensor 360 of FIG. 3) in the call state through communication connection with the external electronic device 101. For example, the processor 320 may identify a non-speech section (e.g., noise only section) other than a section (e.g., speech section) including a speech in the first sound signal obtained through the microphones 350 (or at least a portion of microphones of the microphones 350), identify a non-speech section (e.g., noise only section) other than a section (e.g., speech section) including a speech in the second sound signal obtained through the sensor 360, compare the signal magnitude of the non-speech section of the first sound signal with the signal magnitude of the non-speech section of the second sound signal and identify the level of the external noise signal based on a difference between the signal magnitude of the non-speech section of the first sound signal and the signal magnitude of the non-speech section of the second sound signal.

In operation 730, the processor 320 according to an embodiment may identify a noise level. For example, the processor 320 may identify (determine, judge, or identify) the noise level or identify the level where the external noise signal belongs among the plurality of noise levels based on the identified SNR value (or the level of the external noise signal). The processor 320 according to an embodiment may identify which noise level the current noise level belongs to, of the first noise level (e.g., the quiet environment), the second noise level (e.g., the normal environment), and the third noise level (e.g., the noisy environment), based on the identified SNR value (or the level of the external noise signal).

In operation 740, the processor 320 according to an embodiment may control to turn on (e.g., activate or operate) a portion of microphones (e.g., one or two of the first microphone 351, the second microphone 352, or the third microphone 353) of the first microphone 351 to the third microphone 353 and may control to turn off (e.g., deactivate or not operate) the sensor 360 based on the noise level being the first noise level. The processor 320 according to an embodiment may further control the processing clock of the processor 320 to be the first clock count (or the first clock range) at the first noise level.

In operation 750, the processor 320 according to an embodiment may control to turn on all of the first microphone 351 to the third microphone 353 based on the noise level being the second noise level, may control to turn on a portion of axis of the three axes of the sensor 360, and may control to turn off the other axis. For example, based on the noise level being the second noise level, the processor 320 may control to turn on a portion of the three axes (e.g., one or two axes) of the sensor 360 and may control to turn off a portion of other axes (e.g., the remaining axes that are not turned on). For example, the processor 320 may control to turn on the first axis of the three axes of the sensor 360 and control to turn off the second axis and the third axis based on the noise level being the second noise level. For example, based on the noise level being the second noise level, the processor 320 may control the first axis and the second axis of the three axes of the sensor 360 to be turned on, and may control the third axis to be turned off. According to an embodiment, even when the number of axes of the sensor 360 exceeds three, only a portion of designated axes may be controlled to be turned on.

The processor 320 according to an embodiment may further control the processing clock of the processor 320 to be the second clock count (or the second clock range) at the second noise level. For example, the first clock may have a clock frequency lower than that of the second clock.

In operation 760, the processor 320 according to an embodiment may control to turn on all of the first microphone 351 to the third microphone 353 and may control to turn on all three axes of the sensor 360, based on the noise level being the third noise level. The processor 320 according to an embodiment may further control the processing clock of the processor 320 to be the third clock count (or the third clock range) at the third noise level. For example, the third clock may have a clock frequency higher than that of the second clock.

In operation 770, the processor 320 according to an embodiment may perform a call function. For example, at the first noise level, the processor 320 may transmit audio data obtained by processing the sound signal received through a portion of microphones (e.g., one or two of the first microphone 351, the second microphone 352, and the third microphone 353) of the first microphone 351 to the third microphone 353 to the external electronic device 101 through the communication module 380 based on the first clock count. For example, at the second noise level, the processor 320 may transmit the audio data obtained by processing the sound signal received in a beamforming manner through the first microphone 351 to the third microphone 353 and the sound signal obtained through a portion of axes of the sensor 360 (e.g., one or two of the first axis, the second axis, and the third axis) to the electronic device 101 through the communication module 380 based on the second clock count. For example, the processor 320 may transmit, to the external electronic device 101 through the communication module 380, the audio data obtained by processing the sound signal received in a beamforming manner through the first microphone 351 to the third microphone 353 and the sound signal obtained through each of the three axes of the sensor 360 based on the third clock frequency at the third noise level.

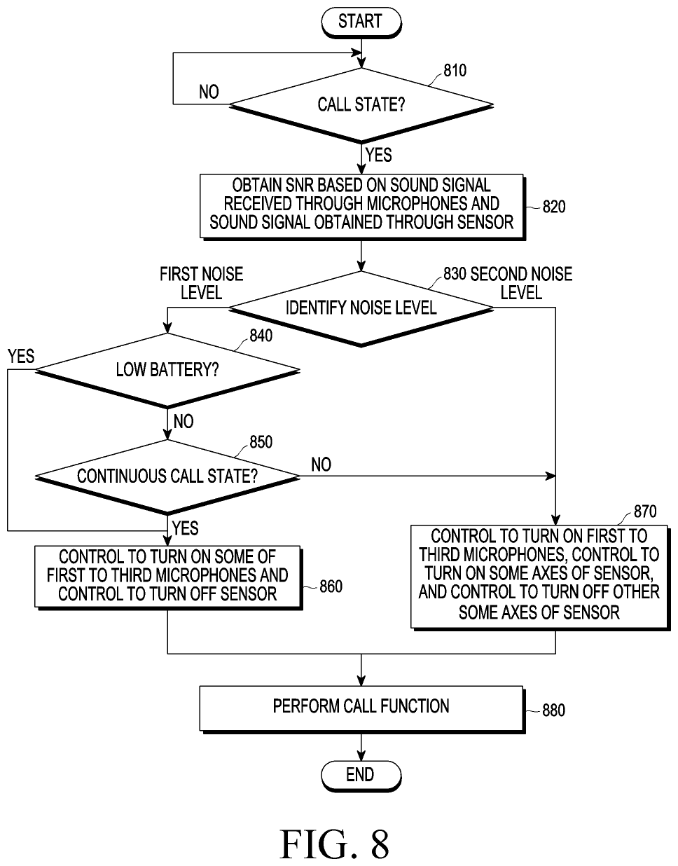

FIG. 8 is a flowchart illustrating an operation of controlling a microphone and a sensor based on a first noise level, a second noise level, and a battery level in an electronic device according to an embodiment.

In operation 810, the processor 320 (e.g., the processor 320 of FIG. 3) according to an embodiment may identify whether a call state is entered through a communication connection with the external electronic device 101 (e.g., the electronic device 101 of FIG. 1 or the electronic device 101 of FIG. 2). For example, the processor 320 may identify whether audio data transmission/reception corresponding to the call state with the external electronic device 101 starts. When the processor 320 is not in the call state, the processor 320 according to an embodiment may perform a function in another state (e.g., an audio data playback function in a music playback state), or may wait or end in an idle state.

In operation 820, the processor 320 according to an embodiment may identify the signal-to-noise ratio (SNR) based on the sound signal (e.g., the first sound signal) obtained through the microphones 350 (e.g., the microphones 350 of FIG. 3) (or at least a portion of the microphones 350) and the sound signal (e.g., the second sound signal) obtained through the sensor 360 (e.g., the sensor 360 of FIG. 3) in the call state through communication connection with the external electronic device 101. For example, the processor 320 may identify a non-speech section (e.g., noise only section) other than a section (e.g., speech section) including a speech in the first sound signal obtained through the microphones 350 (or at least a portion of microphones of the microphones 350), identify a non-speech section (e.g., noise only section) other than a section (e.g., speech section) including a speech in the second sound signal obtained through the sensor 360, compare the signal magnitude of the non-speech section of the first sound signal with the signal magnitude of the non-speech section of the second sound signal and identify the level of the external noise signal based on a difference between the signal magnitude of the non-speech section of the first sound signal and the signal magnitude of the non-speech section of the second sound signal.

In operation 830, the processor 320 according to an embodiment may identify a noise level. For example, the processor 320 may identify (determine, judge, or identify) the noise level or identify the level where the external noise signal belongs among the plurality of noise levels based on the identified SNR value (or the level of the external noise signal). The processor 320 according to an embodiment may identify which noise level the current noise level belongs to, of the first noise level (e.g., the quiet environment) and the second noise level (e.g., the normal environment), based on the identified SNR value (or the level of the external noise signal).

In operation 840, the processor 320 according to an embodiment may identify whether the state of the battery 398 (e.g., the battery 398 of FIG. 3) is a low battery state, based on the noise level being the first noise level. For example, when the battery level is less than or equal to a designated level, the processor 320 may identify it as the low battery state. When the state of the battery 398 is not the low battery state, the processor 320 according to an embodiment may proceed to operation 850, and when the state of the battery 398 is the low battery state, the processor 320 may proceed to operation 860.

In operation 850, the processor 320 according to an embodiment may identify whether it is in the continuous call state. For example, when a call is being performed for a designated time or more during a designated time period, the processor 320 may identify it as the continuous call state. When the processor 320 according to an embodiment is not in the low battery state but is in the continuous call state, the processor 320 may proceed to operation 860. When the processor 320 according to an embodiment is not in the low battery state nor is it in the continuous call state, the processor 320 may proceed to operation 870.

In operation 860, when it is at the first noise level and is in the low battery state or it is at the first noise level and is in the continuous call state, the processor 320 according to an embodiment may control to turn on (e.g., activate or operate) a portion of microphones (e.g., one or two of the first microphone 351, the second microphone 352, and the third microphone 353) of the first microphone 351 to the third microphone 353 and may control to turn off (e.g., deactivate or not operate) the sensor 360. At the first noise level and in the low battery state, or at the first noise level and in the continuous call state, not the low battery state, the processor 320 according to an embodiment may further control the processing clock of the processor 320 to be the first clock count (or the first clock range).

In operation 870, the processor 320 according to an embodiment may control to turn on the first microphone 351 to the third microphone 353, may control to turn on a portion of the three axes of the sensor 360, and may control to turn off a portion of other axes of the sensor 360, at the second noise level or the first noise level and in the continuous call state, not the low battery state. For example, at the second noise level or the first noise level, and in the continuous call state, not the low battery state, the processor 320 may control to turn on the first axis of the three axes of the sensor 360 and may control to turn off the second axis and the third axis. For example, the processor 320 may control the first axis and the second axis of the three axes of the sensor 360 to be turned on and the third axis to be turned off at the second noise level or the first noise level and in the continuous call state, not the low battery state. According to an embodiment, even when the number of axes of the sensor 360 exceeds three, only a portion of designated axes may be controlled to be turned on.

The processor 320 according to an embodiment may further control the processing clock of the processor 320 to be the second clock count (or the second clock range) at the second noise level or the first noise level and in the continuous call state, not the low battery state. For example, the first clock may have a clock frequency lower than that of the second clock.

In operation 880, the processor 320 according to an embodiment may perform a call function. For example, at the first noise level and in the low battery state, or at the first noise level and in the continuous call state, not the low battery state, the processor 320 may transmit audio data obtained by processing the sound signal received through a portion of microphones (e.g., one or two of the first microphone 351, the second microphone 352, and the third microphone 353) of the first microphone 351 to the third microphone 353 to the external electronic device 101 through the communication module 380 based on the first clock count. For example, at the second noise level or the first noise level and in the continuous call state, not the low battery state, the processor 320 may transmit the audio data obtained by processing the sound signal received in a beamforming manner through the first microphone 351 to the third microphone 353 and the sound signal obtained through a portion of axes of the sensor 360 (e.g., at least one or two of the first axis, the second axis, and the third axis) to the external electronic device 101 through the communication module 380 based on the second clock count.

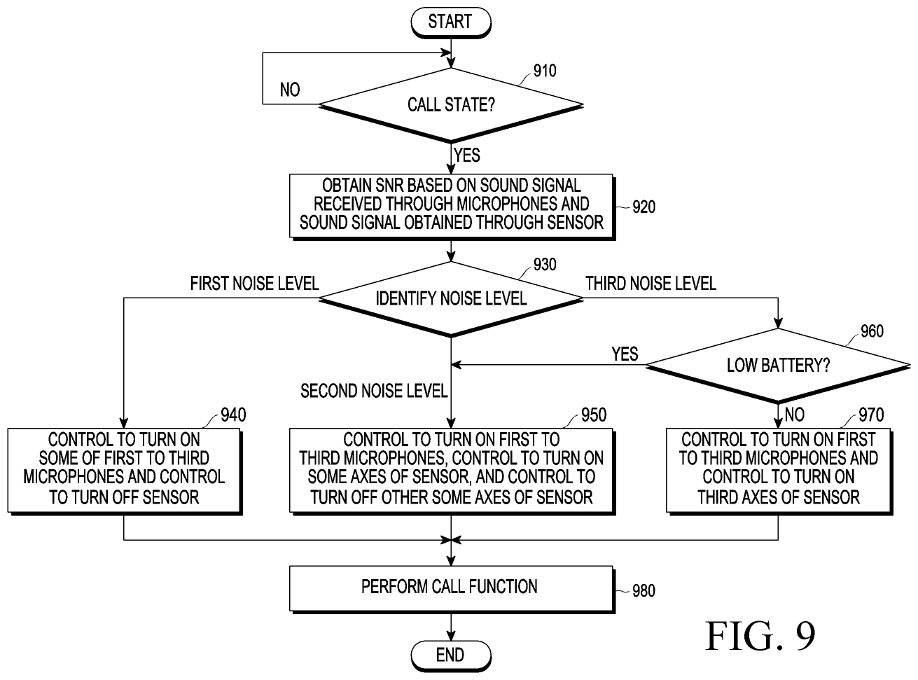

FIG. 9 is a flowchart illustrating an operation of controlling a microphone and a sensor based on a first noise level, a second noise level, a third noise level, and a battery level in an electronic device according to an embodiment.

In operation 910, the processor 320 (e.g., the processor 320 of FIG. 3) according to an embodiment may identify whether a call state is entered through a communication connection with the external electronic device 101 (e.g., the electronic device 101 of FIG. 1 or the electronic device 101 of FIG. 2). For example, the processor 320 may identify whether audio data transmission/reception corresponding to the call state with the external electronic device 101 starts. When the processor 320 is not in the call state, the processor 320 according to an embodiment may perform a function in another state (e.g., an audio data playback function in a music playback state), or may wait or end in an idle state.

In operation 920, the processor 320 according to an embodiment may identify the signal-to-noise ratio (SNR) based on the sound signal (e.g., the first sound signal) obtained through the microphones 350 (e.g., the microphones 350 of FIG. 3) (or at least a portion of the microphones 350) and the sound signal (e.g., the second sound signal) obtained through the sensor 360 (e.g., the sensor 360 of FIG. 3) in the call state through communication connection with the external electronic device 101. For example, the processor 320 may identify a non-speech section (e.g., noise only section) other than a section (e.g., speech section) including a speech in the first sound signal obtained through the microphones 350 (or at least a portion of microphones of the microphones 350), identify a non-speech section (e.g., noise only section) other than a section (e.g., speech section) including a speech in the second sound signal obtained through the sensor 360, compare the signal magnitude of the non-speech section of the first sound signal with the signal magnitude of the non-speech section of the second sound signal and identify the level of the external noise signal based on a difference between the signal magnitude of the non-speech section of the first sound signal and the signal magnitude of the non-speech section of the second sound signal.

In operation 930, the processor 320 according to an embodiment may identify a noise level. For example, the processor 320 may identify (determine, judge, or identify) the noise level or identify the level where the external noise signal belongs among the plurality of noise levels based on the identified SNR value (or the level of the external noise signal). The processor 320 according to an embodiment may identify which noise level the current noise level belongs to, of the first noise level (e.g., the quiet environment), the second noise level (e.g., the normal environment), and the third noise level (e.g., the noisy environment), based on the identified SNR value (or the level of the external noise signal).

In operation 940, the processor 320 according to an embodiment may control to turn on a portion of microphones (e.g., one or two of the first microphone 351, the second microphone 352, or the third microphone 353) of the first microphone 351 to the third microphone 353 and may control to turn off the sensor 360 based on the noise level being the first noise level. The processor 320 according to an embodiment may further control the processing clock of the processor 320 to be the first clock count (or the first clock range) at the first noise level.

In operation 950, the processor 320 according to an embodiment may control to turn on the first microphone 351 to the third microphone 353 based on the noise level being the second noise level, may control to turn on a portion of axis (e.g., one or two of the first axis, the second axis, and the third axis) of the three axes of the sensor 360, and may control to turn off the other axis (e.g., the remaining axis that is not turned on). The processor 320 according to an embodiment may further control the processing clock of the processor 320 to be the second clock count (or the second clock range) at the second noise level. For example, the first clock may have a clock frequency lower than that of the second clock.

In operation 960, the processor 320 according to an embodiment may identify whether the state of the battery 398 (e.g., the battery 398 of FIG. 3) is a low battery state, based on the noise level being the third noise level. For example, when the battery level is less than or equal to a designated level, the processor 320 may identify it as the low battery state. When the state of the battery 398 is the low battery state, the processor 320 according to an embodiment may proceed to operation 950, and when the state of the battery 398 is not the low battery state, the processor 320 may proceed to operation 970.

In operation 970, the processor 320 according to an embodiment may control to turn on the first microphone 351 to the third microphone 353 and may control to turn on the three axes of the sensor 360, based on the noise level being the third noise level and the state of the battery 398 being not the low battery state. The processor 320 according to an embodiment may further control the processing clock of the processor 320 to be the third clock count (or the third clock range) at the third noise level. For example, the third clock may have a clock frequency higher than that of the second clock.

In operation 980, the processor 320 according to an embodiment may perform a call function. For example, at the first noise level, the processor 320 may transmit audio data obtained by processing the sound signal received through a portion of microphones (e.g., one or two of the first microphone 351, the second microphone 352, and the third microphone 353) of the first microphone 351 to the third microphone 353 to the external electronic device 101 through the communication module 380 based on the first clock count. For example, at the second noise level or the third noise level but in the low battery state, the processor 320 may transmit the audio data obtained by processing the sound signal received in a beamforming manner through the first microphone 351 to the third microphone 353 and the sound signal obtained through a portion of axes of the sensor 360 (e.g., at least one or two of the first axis, the second axis, and the third axis) to the external electronic device 101 through the communication module 380 based on the second clock count. For example, the processor 320 may transmit, to the external electronic device 101 through the communication module 380, the audio data obtained by processing the sound signal received in a beamforming manner through the first microphone 351 to the third microphone 353 and the sound signal obtained through each of the three axes of the sensor 360 based on the third clock frequency at the third noise level and not in the low battery state.

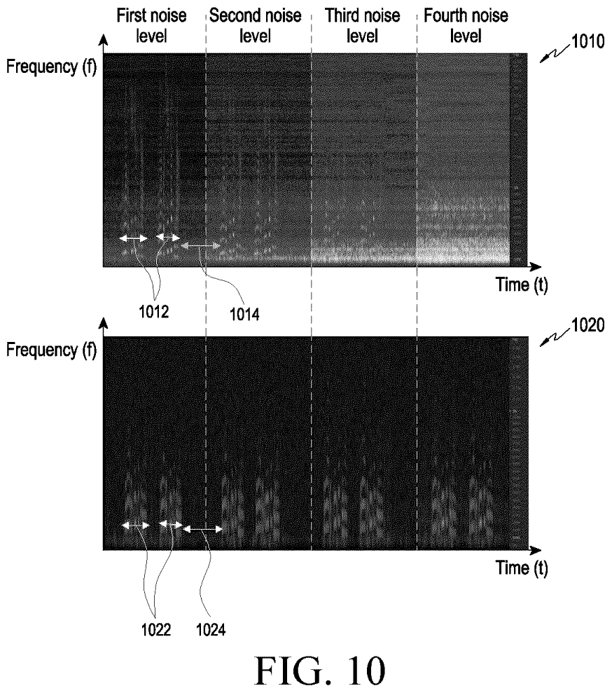

FIG. 10 is a view illustrating an example of identifying a noise level using a sound signal obtained by at least one of microphones and a sound signal obtained by at least one axis of axes of a sensor according to an embodiment.

Referring to FIG. 10, the processor 320 (e.g., the processor 320 of FIG. 3) according to an embodiment may compare the frequency of the sound signal obtained by at least one of the microphones 350 (e.g., the microphones 350 of FIG. 3) with the frequency of the sound signal obtained by at least one of the axes of the sensor 360 (e.g., the sensor 360 of FIG. 3). In a first graph 1010 according to an embodiment, the x-axis may denote the time t, the y-axis may denote the frequency f of the sound signal obtained by at least one of the microphones 350, and the difference in color (or brightness) on the first graph 1010 may denote the difference in noise magnitude (or level) (e.g., dB). For example, the redder the color on the first graph 1010 or the brighter the brightness, the greater the sound signal may be. For example, the first graph 1010 may indicate that as the brightness increases, the sound signal increases. In the second graph 1020 according to an embodiment, the x-axis may denote the time t, the y-axis may denote the frequency f of the sound signal obtained by at least one of the axes of the sensor 360, and the difference in color (or brightness) on the second graph 1020 may denote the difference in magnitude (e.g., dB) of the sound signal. For example, in the second graph 1020, the brighter the brightness, the greater the magnitude of the sound signal, and may mean a section including a speech. The processor 320 according to an embodiment may identify a first non-speech section (e.g., noise only section) 1014 rather than a section (e.g., speech section) 1012 including a speech in the sound signal obtained by at least one of the microphones 350, identify a second non-speech section (e.g., noise only section) 1024 rather than a section (e.g., speech section) 1022 including a speech in the sound signal obtained through at least one of the axes of the sensor 360, compare the signal magnitude of the first non-speech section 1014 and the signal magnitude of the second non-speech section 1024, and identify the level of the external noise signal based on a difference between the signal magnitude of the first non-speech section 1014 and the signal magnitude of the second non-speech section 1024. For example, if the difference between the signal magnitude of the first non-speech section 1014 and the signal magnitude of the second non-speech section 1024 is less than or equal to a designated fourth threshold, the processor 320 may identify it as a first noise level (e.g., a quiet environment), if the difference between the signal magnitude of the first non-speech section 1014 and the signal magnitude of the second non-speech section 1024 is larger than the fourth threshold and less than or equal to a fifth threshold (larger than the fourth threshold), the processor 320 may identify it as a second noise level (e.g., a normal environment), if the difference between the signal magnitude of the first non-speech section 1014 and the signal magnitude of the second non-speech section 1024 is larger than the fifth threshold and equal to or larger than a sixth threshold (larger than the fifth threshold), the processor 320 may identify it as a third noise level (e.g., a noisy environment), and if the difference between the signal magnitude of the first non-speech section 1014 and the signal magnitude of the second non-speech section 1024 exceeds the sixth threshold, the processor 320 may identify it as a fourth noise level (e.g., a high noisy environment).

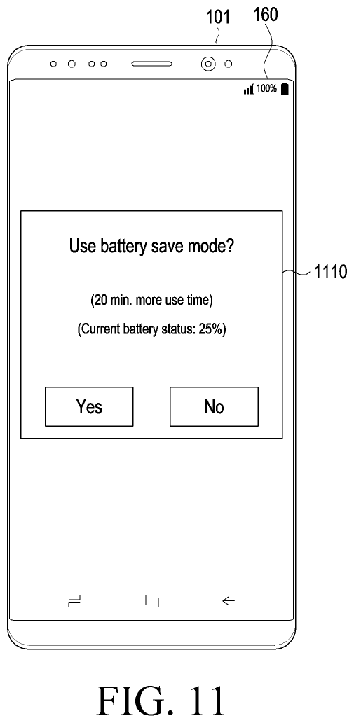

FIG. 11 is a view illustrating a notification screen according to a battery state of an electronic device according to an embodiment.

Referring to FIG. 11, when the state of the battery 398 (e.g., the battery 398 of FIG. 3) is the low battery state (e.g., the battery level is about 25% or less), the processor 320 (e.g., the processor 320 of FIG. 3) according to an embodiment may transmit information indicating that the state of the battery 398 is the low battery state to the external electronic device 101 through the communication module 380 (e.g., the communication module 380 of FIG. 3). The processor 120 (e.g., the processor 120 of FIG. 1) of the external electronic device 101 (e.g., the electronic device 101 of FIG. 1 or the electronic device 101 of FIG. 2) according to an embodiment may display information 1110 indicating that the electronic device 202, 202a, or 202b is in the low battery state on the display 160 (e.g., the display module 160 of FIG. 1) as information indicating the low battery state is received from the electronic device (e.g., the electronic device 102 of FIG. 1, the electronic device 202a of FIG. 2, or the electronic device 202b of FIG. 2). For example, the information 1110 indicating the low battery state may include the current battery state (e.g., about 25%), information related to the extension of the battery usage time, and/or information for identifying whether the battery save mode is used.

According to various embodiments, an electronic device such as a wireless earphone may reduce power consumption by selectively using at least a portion of a plurality of microphones depending on whether the external noise level is low or high.

According to various embodiments, an electronic device such as a wireless earphone may reduce power consumption by selectively controlling the operation of a sensor for removing external noise as well as capable of selectively using at least a portion of a plurality of microphones based on the external noise level.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program products may be traded as commodities between sellers and buyers. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

According to various embodiments, in a non-volatile storage medium storing instructions, the instructions configured to, when executed by at least one processor in an electronic device, enable the at least one processor to perform at least one operation. The at least one operation may comprise obtaining a first sound signal through at least a portion of microphones of the electronic device, obtaining a second sound signal through a sensor of the electronic device, identifying a noise level among a plurality of noise levels based on the first sound signal and the second sound signal, controlling to turn on or off each of the microphones based on the identified noise level, and controlling to turn on or off each of a plurality of axes of the sensor based on the identified noise level.

The embodiments shown and described in the specification and the drawings are provided merely for better understanding of the disclosure, and the disclosure should not be limited thereto or thereby. It should be appreciated by one of ordinary skill in the art that various changes in form or detail may be made to the embodiments without departing from the scope of the present disclosure defined by the following claims.

What is claimed is:

1. An electronic device, comprising:
a sensor;
a plurality of microphones;
one or more processors; and
memory storing instructions that, when executed by the one or more processors, cause the electronic device to:
obtain a first sound signal through at least one of the plurality of microphones;
obtain a second sound signal through at least one of a plurality of axes of the sensor;
identify a noise level from among a plurality of noise levels based on the first sound signal and the second sound signal;
control one or more of the plurality of microphones to be turned on or off based on the noise level; and
control one or more of the plurality of axes to be turned on or off based on the noise level.

2. The electronic device of claim 1, further comprising a communication interface,
wherein the one or more processors are configured to execute the instructions to cause the electronic device to identify the noise level based on the electronic device being in a call state with an external electronic device using the communication interface.

3. The electronic device of claim 1, wherein the plurality of microphones comprise a first microphone, a second microphone, and a third microphone, and the sensor comprises a three-axis acceleration sensor.

4. The electronic device of claim 1, wherein the plurality of noise levels comprise a first noise level and at least one of a second noise level or a third noise level.

5. The electronic device of claim 4, wherein the one or more processors are configured to execute the instructions to cause the electronic device to:
based on the noise level being the first noise level:
turn on at least one from among the first microphone, the second microphone, and the third microphone; and
turn off the three-axis acceleration sensor,
based on the noise level being the second noise level:
turn on the first microphone, the second microphone, and the third microphone;
turn on one or more axes of the three-axis acceleration sensor; and turn off one or more other axes of the three-axis acceleration sensor, and
based on the noise level being the third noise level:
turn on the first microphone, the second microphone, and the third microphone; and
turn on a first axis, a second axis, and a third axis of the three-axis acceleration sensor.

6. The electronic device of claim 4, wherein the one or more processors are configured to execute the instructions to cause the electronic device to:
based on the noise level being the first noise level, control a processing clock of the processor to be a first clock frequency range,
based on the noise level being the second noise level, control the processing clock of the processor to be a second clock frequency range, and
based on the noise level being the third noise level, control the processing clock of the processor to be a third clock frequency range,
wherein the first clock frequency range is less than the second clock frequency range, and the second clock frequency range is less than the third clock frequency range.

7. The electronic device of claim 3, wherein the one or more processors are configured to execute the instructions to cause the electronic device to:
based on the noise level being the first noise level and a battery level of the electronic device being less than or equal to a designated battery level, or based on the electronic device being in a continuous call state, the noise level being the first noise level, and the battery level exceeding the designated battery level:
turn on one of the first microphone;
the second microphone, and the third microphone; and
turn off the three-axis acceleration sensor; and
based on the electronic device not being in the continuous call state, the noise level being the first noise level, and the battery level of the electronic device exceeding the designated battery level, or based on the noise level being the second noise level:
turn on the first microphone, the second microphone, and the third microphone;
turn on one or more axes of the three-axis acceleration sensor; and
turn off one or more other axes of the three-axis acceleration sensor.

8. The electronic device of claim 3, wherein the one or more processors are configured to execute the instructions to cause the electronic device to:
based on the noise level being the first noise level:
turn on at least one from among the first microphone, the second microphone, and the third microphone; and
turn off the three-axis acceleration sensor;
based on the noise level being the second noise level or based on the noise level being the third noise level and a battery level of the electronic device being less than or equal to a designated battery level:
turn on the first microphone, the second microphone, and the third microphone;
turn on one or more axes of the three-axis acceleration sensor; and
turn off one or more other axes of the three-axis acceleration sensor; and
based on the noise level being the third noise level and the battery level exceeding the designated battery level:
turn on the first microphone, the second microphone, and the third microphone; and
turn on a first axis, a second axis, and a third axis of the three-axis acceleration sensor.

9. The electronic device of claim 1, wherein the one or more processors are configured to execute the instructions to cause the electronic device to:
identify a first speech section and a first non-speech section in the first sound signal;
identify a second speech section and a second non-speech section in the second sound signal; and
identify the noise level based on a difference between a first signal magnitude of the first non-speech section and a second signal magnitude of the second non-speech section.

10. A method of controlling an electronic device based on external noise, comprising:
obtaining a first sound signal through at least one of a plurality of microphones of the electronic device;
obtaining a second sound signal through at least one of a plurality of axes of a sensor of the electronic device;
identifying a noise level from among a plurality of noise levels based on the first sound signal and the second sound signal;
controlling one or more of the plurality of microphones to be turned on or off based on the noise level; and
controlling one or more of the plurality of axes to be turned on or off based on the noise level.

11. The method of claim 10, further comprising identifying the noise level based on the electronic device being in a call state with an external electronic device using a communication interface of the electronic device.

12. The method of claim 10, wherein the plurality of microphones include a first microphone, a second microphone, and a third microphone, and the sensor includes a three-axis acceleration sensor.

13. The method of claim 12, wherein the plurality of noise levels comprise a first noise level and at least one of a second noise level or a third noise level.

14. The method of claim 13, further comprising:
based on the noise level being the first noise level:
turning on from among the first microphone, the second microphone; and the third microphone, and
turning off the three-axis acceleration sensor;
based on the noise level being the second noise level:
turning on the first microphone, the second microphone, and the third microphone;
turning on one or more axes of the three-axis acceleration sensor, and
turning off one or more other axes of the three-axis acceleration sensor;
based on the noise level being the third noise level:
turning on the first microphone, the second microphone, and the third microphone, and
turning on a first axis, a second axis, and a third axis of the three-axis acceleration sensor.

15. The method of claim 14, further comprising:
based on the noise level being the first noise level, controlling a processing clock of the processor to be a first clock frequency range,
based on the noise level being the second noise level, controlling the processing clock of the processor to be a second clock frequency range, and
based on the noise level being the third noise level, controlling the processing clock of the processor to be a third clock frequency range, and
wherein the first clock frequency range is less than or equal to the second clock frequency range, and the second clock frequency range is less than or equal to the third clock frequency range.

16. The method of claim 13, further comprising:
based on the noise level is the first noise level and a battery level of the electronic device being less than or equal to a designated battery level, or based on the electronic device being in a continuous call state, the noise level being the first noise level, and the battery level exceeding the designated battery level;
turning on one of the first microphone, the second microphone, and the third microphone; and
turning off the three-axis acceleration sensor; and
based on the electronic device not being in the continuous call state, the noise level being the first noise level, and the battery level exceeding the designated battery level, or based on the noise level being the second noise level:
turning on the first microphone, the second microphone, and the third microphone;
turning on one or more axes of the three-axis acceleration sensor; and
turning off one or more other axes of the three-axis acceleration sensor.

17. The method of claim 13, further comprising:
based on the noise level being the first noise level:
turning on at least one from among the first microphone, the second microphone, and the third microphone; and
turning off the three-axis acceleration sensor;
based on the noise level being the second noise level or based on the noise level being the third noise level and a battery level of the electronic device being less than or equal to a designated battery level:
turning on the first microphone, the second microphone, and the third microphone;
turning on a portion of axes of the three-axis acceleration sensor; and
turning off another portion of axes of the three-axis acceleration sensor; and
based on the noise level being the third noise level and the battery level exceeding the designated battery level:
turning on the first microphone, the second microphone, and the third microphone; and
turning on a first axis, a second axis, and a third axis of the three-axis acceleration sensor.

18. The method of claim 10, further comprising:
identifying a first speech section and a first non-speech section in the first sound signal;
identifying a second speech section and a second non-speech section in the second sound signal; and
identifying the noise level based on a difference between a first signal magnitude of the first non-speech section and a second signal magnitude of the second non-speech section.

19. A non-transitory computer-readable recording medium having instructions recorded thereon, that, when executed by at least one processor, cause the at least one processor to:
obtain a first sound signal through at least one of a plurality of microphones of an electronic device;
obtain a second sound signal through at least one of a plurality of axes of a sensor of the electronic device;
identify a noise level from among a plurality of noise levels based on the first sound signal and the second sound signal;
control one or more of the plurality of microphones to be turned on or off based on the noise level; and
control one or more of the plurality of axes to be turned on or off based on the noise level.

20. The non-transitory computer-readable recording medium of claim 19,
wherein the instructions, when executed by at least one processor, cause the at least one processor further to identify the noise level based on the electronic device being in a call state with an external electronic device using a communication interface of the electronic device.
